(19) United States
(12) Patent Application Publication
(10) Pub. No.: US 2026/0156124 A1
(43) Pub. Date: Jun. 4, 2026

(54) NETWORK DEVICE FOR GROUPING AND CONTROLLING RESOURCES AND METHOD OF OPERATING THE SAME

(71) Applicant: ELECTRONICS AND TELECOMMUNICATIONS RESEARCH INSTITUTE, Daejeon (KR)

(72) Inventors: YOUNG HO KIM, Daejeon (KR); Young Sae KIM, Daejeon (KR); Jeong Nyeo KIM, Daejeon (KR); Wooyeol YANG, Daejeon (KR); Sang-Min LEE, Daejeon (KR); Yun-Kyung LEE, Daejeon (KR)

(21) Appl. No.: 19/384,885

(22) Filed: Nov. 10, 2025

(30) Foreign Application Priority Data
Dec. 3, 2024 (KR) 10-2024-0177163
Oct. 28, 2025 (KR) 10-2025-0158238

(51) Int. Cl. H04L 9/40; H04L 43/02

(52) U.S. Cl. CPC H04L 63/1416; H04L 43/02

(57) ABSTRACT

A network device for grouping and controlling resources and a method of operating the network device are provided. The method of operating the network device includes based on information obtained through dynamic action monitoring, detecting a network attack on resources managed in a network, based on target resources determined as victims of the network attack among the resources, determining a constraint condition of affinity groups for the resources, based on the target resources, the constraint condition, and a determined affinity group size, grouping the resources managed in the network into the affinity groups, and determining a control policy of the network according to the affinity groups.

### CROSS-REFERENCE TO RELATED APPLICATIONS

This application claims the benefit of Korean Patent Application No. 10-2024-0177163, filed on Dec. 3, 2024, and Korean Patent Application No. 10-2025-0158238, filed on Oct. 28, 2025, in the Korean Intellectual Property Office, the entire disclosure of which is incorporated herein by reference for all purposes.

### BACKGROUND

### 1. Field of the Invention

One or more embodiments relate to a network device for grouping and controlling resources and a method of operating the network device.

### 2. Description of the Related Art

A network be a structure in which various devices (e.g., computers) are connected to one another, enabling the devices to exchange data and information. With recent advancements in information and communication technology, various devices are interconnected through networks, increasing the number of data transmission, reception, and processing processes. A network may include a plurality of nodes and links and may be utilized as infrastructure that enables data transmission, service provision, and resource sharing between devices.

A network may be divided into a resource layer, where data traffic is generated, and a control and management layer, which manages the resource layer. Network attacks may include, for example, sniffing, spoofing, malware attacks, or denial-of-service (DoS) attacks. For example, a DoS attack on a network may be an attack that concentrates excessive traffic on network resources, preventing the system from processing normal user requests.

The above description is information the inventor(s) acquired during the course of conceiving the present disclosure, or already possessed at the time, and is not necessarily art publicly known before the present application was filed.

### SUMMARY

Various embodiments may group resources managed in a network into affinity groups and manage and control the resources on an affinity group basis.

Various embodiments may detect a network attack on resources and group the resources into affinity groups based on target resources determined as victims of the network attack.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided a method of operating a network device, the method including, based on information obtained through dynamic action monitoring, detecting a network attack on resources managed in a network, based on target resources determined as victims of the network attack among the resources, determining a constraint condition of affinity groups for the resources, based on the target resources, the constraint condition, and a determined affinity group size, grouping the resources managed in the network into the affinity groups, and determining a control policy of the network according to the affinity groups.

The detecting of the network attack may include determining, as the network attack, a target behavior to be analyzed among behaviors obtained through dynamic action monitoring and based on packets and log information of the resources, detecting a behavior corresponding to the network attack among the behaviors.

The grouping of the resources into the affinity groups may include, based on static information and a behavior analysis result related to the resources, grouping the resources.

The static information may include at least one of types of the resources, position information, an operating software list, and network connection information.

The determining of the control policy may include controlling the resources included in the affinity groups for the target resources to be isolated from the network.

The determining of the constraint condition may include determining the constraint condition so that the target resources are grouped into a same affinity group.

The method may further include visualizing and outputting attribute information of the affinity groups and resources included in the affinity groups by identifying a correlation between the affinity groups.

According to another aspect, there is provided a method of operating a network device for managing a network structure including a resource plane, a semantic plane, a management plane, and a control plane, the method including determining, as a network attack, a target behavior to be analyzed in the management plane, based on information obtained through dynamic action monitoring in the semantic plane, detecting the network attack on resources managed in the resource plane, based on target resources determined as victims of the network attack among the resources in the semantic plane, determining a constraint condition of affinity groups for the resources, based on the target resources, the constraint condition, and a determined affinity group size in the semantic plane, grouping the resources managed in the resource plane into the affinity groups, and determining a control policy of a network according to the affinity groups in the control plane.

The detecting of the network attack may include, based on packets and log information of the resources in the semantic plane, detecting a behavior corresponding to the network attack among behaviors obtained through dynamic action monitoring.

The grouping of the resources into the affinity groups may include, based on static information and a behavior analysis result related to the resources in the semantic plane, grouping the resources.

The determining of the control policy may include controlling the resources included in the affinity groups for the target resources in the control plane to be isolated from the network.

The determining of the constraint condition may include determining the constraint condition so that the target resources are grouped into a same affinity group.

According to another aspect, there is provided a network device including a processor and memory storing instructions, wherein the instructions, when executed by the processor, may cause the network device to, based on information obtained through dynamic action monitoring, detect a network attack on resources managed in a network, based on target resources determined as victims of the network attack among the resources, determine a constraint condition of affinity groups for the resources, based on the target resources, the constraint condition, and a determined affinity group size, group the resources managed in the network into the affinity groups, and determine a control policy of the network according to the affinity groups.

The instructions, when executed by the processor, may cause the network device to determine, as the network attack, a target behavior to be analyzed among behaviors obtained through dynamic action monitoring and based on packets and log information of the resources, detect a behavior corresponding to the network attack among the behaviors.

The instructions, when executed by the processor, may cause the network device to, based on static information and a behavior analysis result related to the resources, group the resources.

The static information may include at least one of types of the resources, position information, an operating software list, and network connection information.

The instructions, when executed by the processor, may cause the network device to control resources included in affinity groups for the target resources to be isolated from the network.

The instructions, when executed by the processor, may cause the network device to determine the constraint condition so that the target resources are grouped into a same affinity group.

The instructions, when executed by the processor, may cause the network device to visualize and output attribute information of the affinity groups and resources included in the affinity groups by identifying a correlation between the affinity groups.

Additional aspects of embodiments will be set forth in part in the description which follows and, in part, will be apparent from the description, or may be learned by practice of the disclosure.

Various embodiments may group resources into affinity groups based on attributes of the resources, enabling rapid and efficient responses to changing security situations and network attacks.

Various embodiments may efficiently respond to network security threats and control resources even when the types and number of resources are large by processing the resources on an affinity group basis, from detecting attack risks to determining and controlling potentially dangerous resources. This may reduce risks and control policy complexity associated with network expansion.

Various embodiments may control resources based on a correlation between the resources, facilitating proactive and rapid responses and strengthening security not only for target resources targeted by a network attack but also for resources associated with the target resources.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a structure of a network according to an embodiment;

FIG. 2 is a diagram illustrating operations of a network device, according to an embodiment;

FIG. 3 is a diagram illustrating an operation of grouping resources into affinity groups according to an embodiment;

FIG. 4 is a diagram illustrating a process in which a network device controls resources based on affinity groups, according to an embodiment;

FIG. 5 is a flowchart illustrating a method of operating a network device, according to an embodiment; and

FIG. 6 is a block diagram illustrating a network device according to an embodiment.

### DETAILED DESCRIPTION

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Although terms, such as first, second, and the like, may be used herein to describe various components, these terms should be used only to distinguish one component from another component. For example, a first component may be referred to as a second component, and similarly the second component may also be referred to as the first component.

It should be noted that if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals refer to like components and a repeated description related thereto will be omitted.

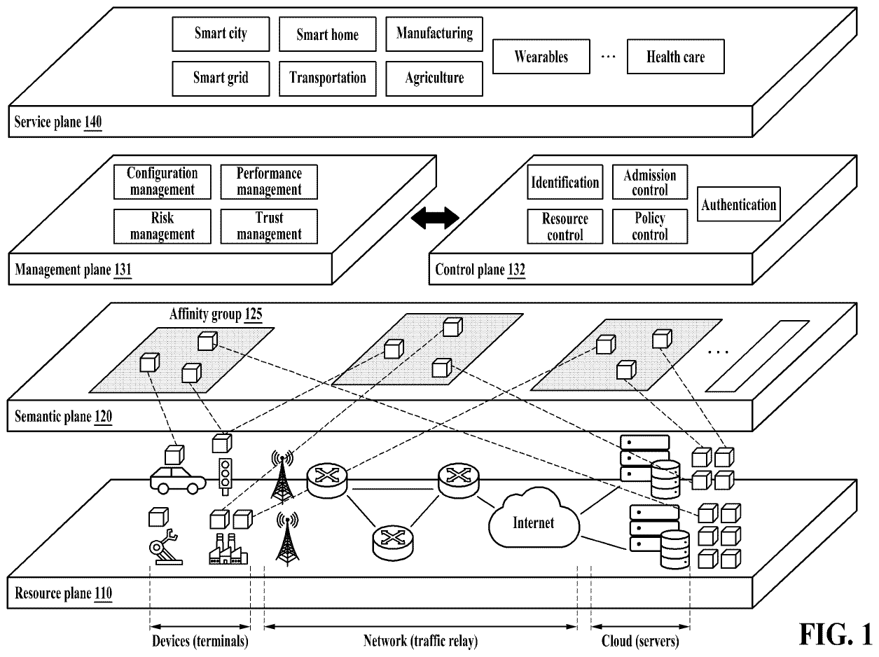

FIG. 1 is a diagram illustrating a structure of a network according to an embodiment.

Referring to FIG. 1, a network may include a resource plane 110, a semantic plane 120, a management plane 131, a control plane 132, and a service plane 140. The network may have a hierarchical structure based on the planes illustrated in FIG. 1. The structure of the network illustrated in FIG. 1 is an example for description, and embodiments are not limited thereto. For example, the network may be implemented by merging or omitting some of the planes illustrated in FIG. 1 or may further include planes other than the planes illustrated in FIG. 1. Operations of each plane may be performed by at least one component (e.g., a processor, etc.) of a network device.

The resource plane 110 may be a layer in which data traffic of devices connected to the network is generated. The resource plane 110 may include physical components (e.g., an Internet of Things (IoT) terminal device, a traffic relay device, and a cloud server) and internal resources of each physical component.

The semantic plane 120 may be a layer that groups resources of the resource plane 110 into affinity groups 125. The semantic plane 120 may improve situational processing by organizing resources into the affinity groups 125. The affinity groups 125 may be generated regardless of device type, manufacturer, or communication techniques, and various management and control mechanisms may be applied.

The management plane 131 may be a layer responsible for managing configuration, performance, risk, and trust for the network.

The control plane 132 may be a layer that provides execution functions related to identification, access control, resource control, policy control, and authentication for the network.

The service plane 140 may be a layer that provides an application-level service (e.g., smart city, healthcare, and transportation). For example, the service plane 140 may provide a service for a smart city, a smart grid, a smart home, transportation, manufacturing, agriculture, wearables, or healthcare, but embodiments are not limited thereto.

According to an embodiment, the network device may group resources into the affinity groups 125 based on target resources determined as victims of a network attack in the semantic plane 120. The network device may manage and control the resources of the network by organizing the resources into the affinity groups 125, thereby reducing the risk of network attacks and proactively responding to the spread of risks.

A grouping technique may simplify a management task by logically grouping resources based on functions, positions, or other relevant criteria. Making a decision at a group level may reduce the complexity of management processes compared to handling individual resources. Resource affinity may refer to disposing two or more resources in close proximity to one another in order to increase bandwidth and improve communication between the resources. In addition to enabling efficient resource placement, resource affinity may enhance resource management by addressing configuration, risk, and trust-related issues. In an embodiment, an affinity-based grouping technique may enable intelligent management and provide flexible control over resources. Resources within an affinity group may share similar properties and semantic attributes. According to an embodiment, the network device may use artificial intelligence (AI) to group resources into affinity groups. AI may further advance affinity-based grouping by uncovering hidden relationships between resources. Relational intelligence derived from affinity groups may improve efficiency and scalability, even supporting network resource management.

According to an embodiment, the network device may help build a framework for managing network resource affinity groups 125 in an AI of things (AIoT) environment. Grouping resources into the affinity groups 125 may facilitate intelligent management and flexible control of network resources. Relational intelligence derived from the affinity groups 125 may simplify a decision-making process and improve the scalability of an IoT service. For example, the decision-making process may range from access control for network management to selecting an on-device AI model for an edge device, but embodiments are not limited thereto.

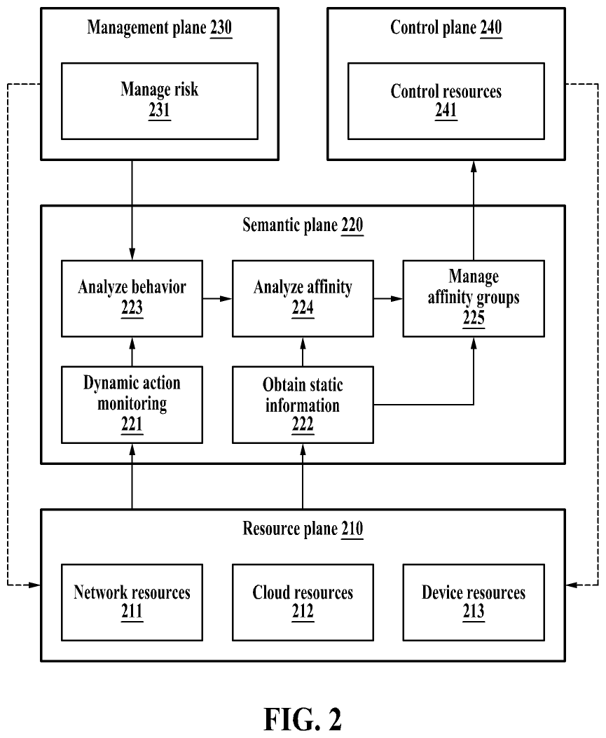

FIG. 2 is a diagram illustrating operations of a network device, according to an embodiment.

Referring to FIG. 2, operations performed by a resource plane 210, a semantic plane 220, a management plane 230, and a control plane 240 included in a network structure are illustrated as an example. In the following embodiments, operations may be performed sequentially but not necessarily. For example, the order of the operations may change, and at least two of the operations may be performed in parallel. Operations 211 to 241 may be performed by at least one component (e.g., a processor, etc.) of a network device.

Operations 211 to 213 may be performed in the resource plane 210 of the network device.

In operation 211, the network device may obtain network resources for relaying traffic.

In operation 212, the network device may obtain cloud resources generated from a cloud (or a server).

In operation 213, the network device may obtain device resources generated from terminal devices.

The network device may include a static information obtainer, a dynamic action monitoring portion, a behavior analyzer, an affinity analyzer, and an affinity group management portion. The static information obtainer, the dynamic action monitoring portion, the behavior analyzer, the affinity analyzer, and the affinity group management portion may be implemented as separately provided hardware or modules but may be implemented by at least one component (e.g., a processor, etc.) included in the network device according to an embodiment. For example, a processor included in the network device may perform operations of the static information obtainer, the dynamic action monitoring portion, the behavior analyzer, the affinity analyzer, and the affinity group management portion.

Operations 221 to 225 may be performed in the semantic plane 220 of the network device.

In operation 221, the dynamic action monitoring portion of the network device may monitor and obtain dynamic status information (e.g., log information and network packets) that occurs while resources are in operation. For example, log information recorded by resources during operation may be expressed in unstructured text format, as the log format of the log information varies depending on the resource type and role. Additionally, network packets transmitted and received through the resources may be non-standard dynamic information and may be targets for monitoring.

In operation 222, the static information obtainer of the network device may obtain primary attribute information of the resources directly or indirectly from the resources. Attribute information may be a structure expressed in the form of a formal data schema and may include primary information including types of resources, position information, an operating software list, and network connection information. For example, static information may include at least one of the types of the resources, position information, an operating software list, and network connection information. Obtaining static information may include either automatic obtaining through a network or manual input.

In operation 223, the behavior analyzer of the network device may search for resources corresponding to a designated behavior from the management plane 230 based on resource dynamic information obtained from the dynamic action monitoring portion. For example, when a network attack on a network connection is designated as a target behavior for analysis, the behavior analyzer may detect whether a network attack occurs through packets and log information of the resources and select resources that are the target of the network attack. For example, the target behavior of analysis may be expressed as an abnormal or malicious behavior from a security perspective, and a designated behavior may be detected through network packets or authentication log information. Herein, for ease of description, the term “target behavior for analysis” may be referred to as a “target behavior.” For example, an anomaly detection-based or behavior-based detection technique including statistical modeling, machine learning, or a history-based learning technique may be used to detect a designated behavior, but embodiments are not limited thereto.

In operation 224, based on resource-related static information and a behavior analysis result, the affinity analyzer of the network device may generate affinity groups and assign resources to corresponding affinity groups. An affinity group may be generated by utilizing attribute information, which is static information of resources, as multidimensional characteristic information so that the resources identified from a behavior analysis result are assigned to the same affinity group. An affinity group may be generated using a clustering algorithm, including K-means, density-based spatial clustering of applications with noise (DBSCAN), or a Gaussian mixture model (GMM), for example. However, embodiments are not limited thereto. For example, the affinity analyzer may utilize a constrained optimization problem-KMeans (COP-KMeans) technique, which applies a constraint condition (e.g., “must-link”) to ensure that the resources identified from the behavior analysis result are restricted to exist within the same cluster. A clustering technique for generating an affinity group is not limited to a predetermined technique, and various clustering techniques may be used depending on the embodiment.

In operation 225, the affinity group management portion of the network device may visualize affinity groups generated by the affinity analyzer and provide information on resources included in the affinity groups. Herein, for ease of description, resources included in affinity groups may also be referred to as member resources. Visualization may help identify and understand a correlation between affinity groups that are difficult to identify through simple comparison of attribute information by identifying multidimensional attribute information of the affinity groups and resources included in the affinity groups. The affinity group management portion, along with visualization, may provide information on affinity groups and internal resources, allowing for external management and control of resources on an affinity group basis. For example, when receiving, from the affinity group management portion, information about affinity groups of resources that have recently been targeted by a network attack, the control plane 240 may enable a preemptive response by determining the resources included in the affinity groups as potential risk factors and isolating or recovering the resources from a network. Herein, for ease of description, resources that are targeted by a network attack may also be referred to as target resources.

The network device may include a risk management portion and a resource controller. The risk management portion and the resource controller may be implemented as separately provided hardware or modules but may also be implemented by at least one component (e.g., a processor, etc.) included in the network device, depending on the embodiment. For example, the processor included in the network device may perform operations of the risk management portion and the resource controller.

In operation 231, the risk management portion of the network device may manage the risk of a network attack by designating a target behavior for analysis. Operation 231 may be performed in the management plane 230 of the network device.

In operation 241, the resource management portion of the network device may manage and control resources grouped into affinity groups. The network device may determine a control policy to control resources of the network according to the affinity groups. Operation 241 may be performed in the control plane 240 of the network device.

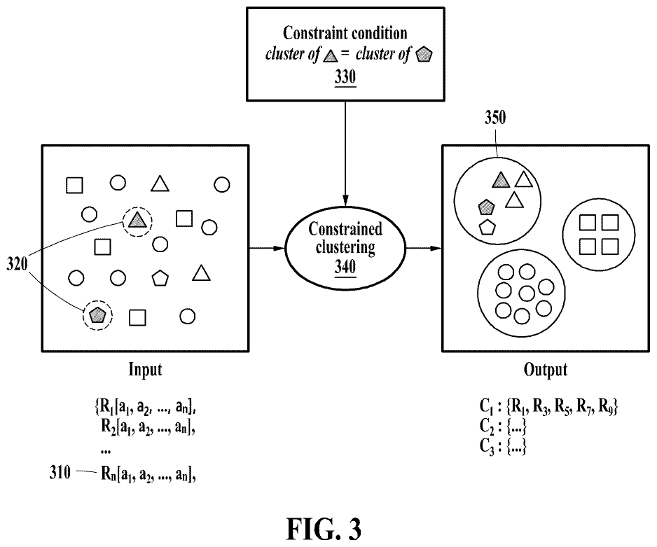

FIG. 3 is a diagram illustrating an operation of grouping resources into affinity groups according to an embodiment.

Referring to FIG. 3, a network device may group resources into affinity groups. According to an embodiment, the network device may group resources into affinity groups by utilizing attribute information, which is static information of the resources, as multidimensional feature information.

According to an embodiment, based on attribute information of resources expressed as feature vectors 310, the network device may generate clusters for the resources using a constrained clustering algorithm 340. Each of the generated clusters may be determined as an affinity group. For example, the network device may determine a constraint condition 330 to ensure that designated resources 320 are included in the same cluster 350 and may perform clustering according to the constraint condition 330. For example, the constrained clustering algorithm may be a COP-KMeans algorithm, but embodiments are not limited thereto. An affinity group for the designated resources 320 may correspond to the cluster 350 that includes the designated resources 320 among the clusters generated through clustering. Additionally, affinity groups may have different sizes (e.g., the number of resources within the cluster 350) depending on the algorithm settings or embodiments. In an embodiment, for efficient resource management and control, the network device may determine the smallest possible cluster 350 as the final affinity group, but the size of the affinity group may be changed depending on an input parameter.

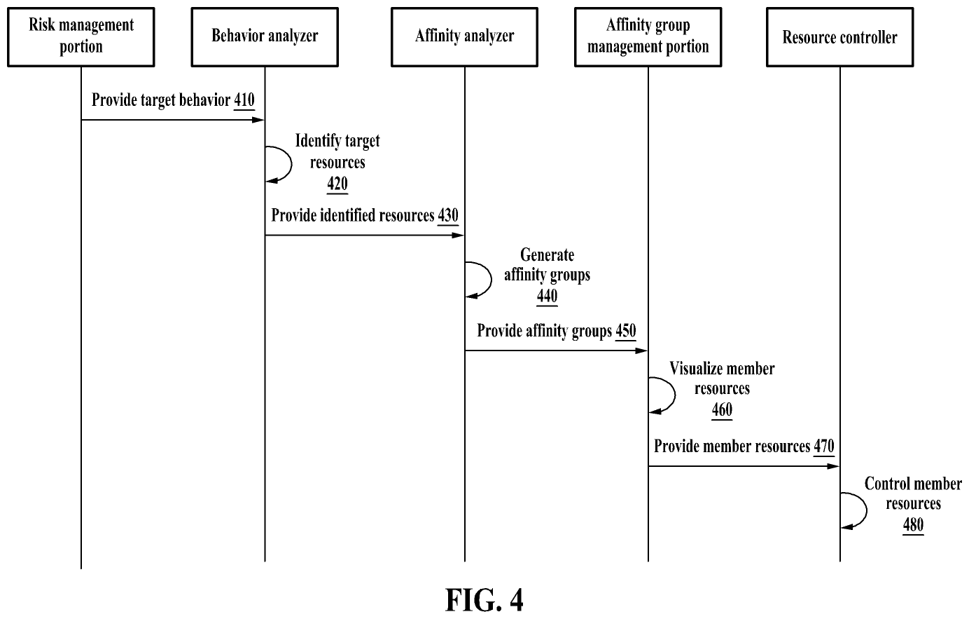

FIG. 4 is a diagram illustrating a process in which a network device controls resources based on affinity groups, according to an embodiment.

Referring to FIG. 4, a network device may group resources managed in a network into affinity groups and determine a control policy of the network according to the affinity groups.

In the following embodiments, operations may be performed sequentially but not necessarily. For example, the order of the operations may change, and at least two of the operations may be performed in parallel. Operations 410 to 480 may be performed by at least one component (e.g., a processor, etc.) of a network device.

In operation 410, a risk management portion may determine a target behavior for which risk is to be managed among monitored behaviors for the resources. For example, in order to proactively prepare for the spread of risks related to a network attack on internal resources, the risk management portion may determine that access control is necessary for resources at risk of being exposed to such attack and determine that the network attack is a target behavior.

In operation 420, the behavior analyzer may identify target resources that are targeted by the target behavior. For example, the behavior analyzer may identify target resources that are targeted by a network attack among resources managed in the network. The behavior analyzer may set a target risk as a network attack and detect a network attack based on information provided by a dynamic action monitoring portion. An attack detection method of the behavior analyzer may be determined differently depending on the embodiment.

In operation 430, the behavior analyzer may provide the identified target resources to an affinity analyzer. The behavior analyzer may determine, a constraint condition of the affinity groups, target resources determined as victims of a network attack.

In operation 440, the affinity analyzer may group resources into affinity groups based on target resources and the constraint condition of the affinity groups. In an embodiment, based on target resources, a constraint condition, and an affinity group size, the affinity analyzer may use a clustering algorithm to generate affinity groups for resources.

In operation 450, the affinity analyzer may provide information about the generated affinity groups to an affinity group management portion.

In operation 460, the affinity group management portion may visualize and output affinity groups and member resources included in the affinity groups. In an embodiment, the affinity group management portion may identify a correlation between the affinity groups and visualize and output attribute information of the affinity groups and the member resources included in the affinity groups.

In operation 470, the affinity group management portion may provide, to a resource controller, information about the affinity groups and the member resources included in the affinity groups. In an embodiment, the affinity group management portion may display internal resources of the generated affinity groups on a screen and provide information about the affinity groups to the resource controller of a control plane.

In operation 480, the resource controller may determine a control policy of the network according to the affinity groups and control the member resources included in the affinity groups according to the control policy. The resource controller may determine a control policy to isolate resources included in the affinity groups for target resources from the network and may control the resources to be isolated according to the control policy. For example, the resource controller may determine a control policy, such as blocking or isolating traffic from a network perspective, for the remaining resources except the target resources determined as the target of a network attack and may control access to the resources through the control policy.

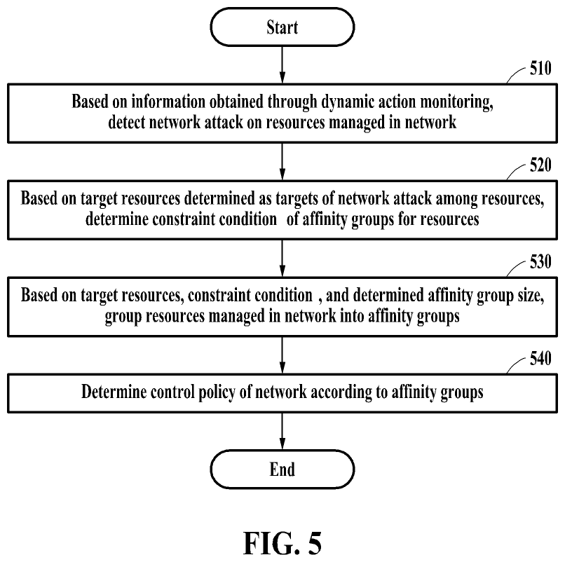

FIG. 5 is a flowchart illustrating a method of operating a network device, according to an embodiment.

In the following embodiments, operations may be performed sequentially but not necessarily. For example, the order of the operations may change, and at least two of the operations may be performed in parallel. Operations 510 to 540 may be performed by at least one component (e.g., a processor, etc.) of a network device.

In operation 510, based on information obtained through dynamic action monitoring, the network device may detect a network attack on resources managed in a network. The network device may determine, as a network attack, a target behavior to be analyzed among behaviors obtained through dynamic action monitoring and may detect a behavior corresponding to the network attack among the behaviors based on packets and log information of resources.

In operation 520, based on target resources determined as victims of the network attack among the resources, the network device may determine a constraint condition of affinity groups for resources. The network device may determine a constraint condition so that the target resources are grouped into the same affinity group.

In operation 530, based on target resources, a constraint condition, and a determined affinity group size, the network device may group the resources managed in the network into affinity groups. Based on static information and a behavior analysis result related to the resources, the network device may group the resources. Static information may include at least one of the types of the resources, position information, an operating software list, and network connection information.

In operation 540, the network device may determine a control policy of the network according to the affinity groups. The network device may control the resources included in the affinity groups for the target resources to be isolated from the network.

The network device may visualize and output attribute information of the affinity groups and resources included in the affinity groups by identifying a correlation between the affinity groups.

The descriptions provided with reference to FIGS. 1 to 4 may apply to the operations shown in FIG. 5, and thus further detailed descriptions are omitted.

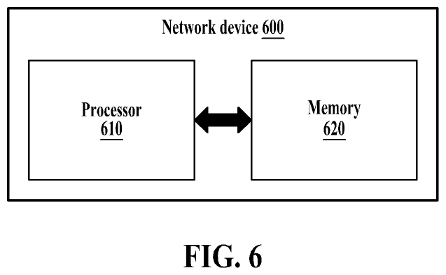

FIG. 6 is a block diagram illustrating a network device according to an embodiment.

Referring to FIG. 6, a network device 600 may include a processor 610. The processor 610 may include at least one processor. Additionally, the network device 600 may further include memory 620.

The memory 620 may store instructions (e.g., programs) executable by the processor 610. For example, the instructions may include instructions for performing an operation of the processor 610 and/or an operation of each component of the processor 610.

The processor 610 is a device that executes commands or programs or controls the network device 600 and may include, for example, various processors such as a central processing unit (CPU) and a graphics processing unit (GPU). Based on information obtained through dynamic action monitoring, the processor 610 may detect a network attack on resources managed in a network. Based on target resources determined as victims of the network attack among the resources, the processor 610 may determine a constraint condition of affinity groups for resources. Based on target resources, a constraint condition, and a determined affinity group size, the processor 610 may group the resources managed in the network into affinity groups. The processor 610 may determine a control policy of the network according to the affinity groups.

The processor 610 may determine, as a network attack, a target behavior to be analyzed among behaviors obtained through dynamic action monitoring and may detect a behavior corresponding to the network attack among the behaviors based on packets and log information of resources. Based on static information and a behavior analysis result related to the resources, the processor 610 may group the resources. The processor 610 may control the resources included in the affinity groups for the target resources to be isolated from the network. The processor 610 may determine a constraint condition so that the target resources are grouped into the same affinity group. The processor 610 may visualize and output attribute information of the affinity groups and resources included in the affinity groups by identifying a correlation between the affinity groups.

In addition, the network device 600 may process the operations described above.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. For example, the device, the method, and the components described in the embodiments may be implemented using a general-purpose or special-purpose computer, such as a processor, a controller and an arithmetic logic unit (ALU), a DSP, a microcomputer, an FPGA, a programmable logic unit (PLU), a microprocessor, or any other devices capable of responding to and executing instructions. A processing device may run an operating system (OS) and software applications that run on the OS. The processing device may also access, store, manipulate, process, and generate data in response to execution of the software. For purpose of simplicity, the description of the processing device is used as singular; however, one skilled in the art will appreciate that a processing device may include multiple processing elements and multiple types of processing elements. For example, the processing device may include a plurality of processors or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in non-transitory computer-readable storage media.

The method according to the embodiments described above may be recorded in non-transitory computer-readable storage media including program instructions to implement various operations of the embodiments described above. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of operating a network device, the method comprising:
based on information obtained through dynamic action monitoring, detecting a network attack on resources managed in a network;
based on target resources determined as victims of the network attack among the resources, determining a constraint condition of affinity groups for the resources;
based on the target resources, the constraint condition, and a determined affinity group size, grouping the resources managed in the network into the affinity groups; and
determining a control policy of the network according to the affinity groups.

2. The method of claim 1, wherein the detecting of the network attack comprises:
determining, as the network attack, a target behavior to be analyzed among behaviors obtained through dynamic action monitoring; and
based on packets and log information of the resources, detecting a behavior corresponding to the network attack among the behaviors.

3. The method of claim 1, wherein the grouping of the resources into the affinity groups comprises, based on static information and a behavior analysis result related to the resources, grouping the resources.

4. The method of claim 3, wherein the static information comprises at least one of types of the resources, position information, an operating software list, and network connection information.

5. The method of claim 1, wherein the determining of the control policy comprises controlling the resources comprised in the affinity groups for the target resources to be isolated from the network.

6. The method of claim 1, wherein the determining of the constraint condition comprises determining the constraint condition so that the target resources are grouped into a same affinity group.

7. The method of claim 1, further comprising:
visualizing and outputting attribute information of the affinity groups and resources comprised in the affinity groups by identifying a correlation between the affinity groups.

8. A non-transitory computer-readable storage medium storing instructions that, when executed by a processor, cause the processor to perform the method of claim 1.

9. A method of operating a network device for managing a network structure comprising a resource plane, a semantic plane, a management plane, and a control plane, the method comprising:
determining, as a network attack, a target behavior to be analyzed in the management plane;
based on information obtained through dynamic action monitoring in the semantic plane, detecting the network attack on resources managed in the resource plane;
based on target resources determined as victims of the network attack among the resources in the semantic plane, determining a constraint condition of affinity groups for the resources;
based on the target resources, the constraint condition, and a determined affinity group size in the semantic plane, grouping the resources managed in the resource plane into the affinity groups; and
determining a control policy of a network according to the affinity groups in the control plane.

10. The method of claim 9, wherein the detecting of the network attack comprises, based on packets and log information of the resources in the semantic plane, detecting a behavior corresponding to the network attack among behaviors obtained through dynamic action monitoring.

11. The method of claim 9, wherein the grouping of the resources into the affinity groups comprises, based on static information and a behavior analysis result related to the resources in the semantic plane, grouping the resources.

12. The method of claim 9, wherein the determining of the control policy comprises controlling the resources comprised in the affinity groups for the target resources in the control plane to be isolated from the network.

13. The method of claim 9, wherein the determining of the constraint condition comprises determining the constraint condition so that the target resources are grouped into a same affinity group.

14. A network device comprising:
a processor; and
memory storing instructions,
wherein the instructions, when executed by the processor, cause the network device to:
based on information obtained through dynamic action monitoring, detect a network attack on resources managed in a network;
based on target resources determined as victims of the network attack among the resources, determine a constraint condition of affinity groups for the resources;
based on the target resources, the constraint condition, and a determined affinity group size, group the resources managed in the network into the affinity groups; and
determine a control policy of the network according to the affinity groups.

15. The network device of claim 14, wherein the instructions, when executed by the processor, cause the network device to:
determine, as the network attack, a target behavior to be analyzed among behaviors obtained through dynamic action monitoring; and
based on packets and log information of the resources, detect a behavior corresponding to the network attack among the behaviors.

16. The network device of claim 14, wherein the instructions, when executed by the processor, cause the network device to, based on static information and a behavior analysis result related to the resources, group the resources.

17. The network device of claim 16, wherein the static information comprises at least one of types of the resources, position information, an operating software list, and network connection information.

18. The network device of claim 14, wherein the instructions, when executed by the processor, cause the network device to control resources comprised in affinity groups for the target resources to be isolated from the network.

19. The network device of claim 14, wherein the instructions, when executed by the processor, cause the network device to determine the constraint condition so that the target resources are grouped into a same affinity group.

20. The network device of claim 14, wherein the instructions, when executed by the processor, cause the network device to visualize and output attribute information of the affinity groups and resources comprised in the affinity groups by identifying a correlation between the affinity groups.
